(19) United States
(12) Patent Application Publication
(10) Pub. No.: US 2005/0096885 A1
(43) Pub. Date: May 5, 2005

(54) System and method for automating the generation of manufacturing frame designs

(75) Inventors: James Scott Rhodes JR., Redmond, WA (US); Craig Bradley McFarlane, Shoreline, WA (US); Michael Glenn Graves, Crawford, NE (US); Peggy Pui-Kei Yuen, Renton, WA (US); William Ross Stewart, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR Inc.

(21) Appl. No.: 10/801,903

(22) Filed: Mar. 16, 2004

Related U.S. Application Data
(60) Provisional application No. 60/517,556, filed on Nov. 5, 2003.

(51) Int. Cl. G06F 17/50

(52) U.S. Cl. 703/1

(57) ABSTRACT

A system and method for automating the generation of manufacturing frame designs are provided. A frame design processing server includes a plurality of modules for generating frame designs. The frame design processing server obtains a specification of components for a vehicle and processes the specification according frame design rules and three-dimensional representations of data. The frame design processing server configures positions for the each of the specified components based upon processing data in the frame design rules and based upon conducting interference checks. The resulting configuration can be exported as manufacturing data and/or three-dimensional representations of the frame design.

### CROSS-REFERENCE TO RELATED APPLICATION

This application claims the benefit of U.S. Provisional Application No. 60/517,556, entitled SYSTEM AND METHOD FOR AUTOMATING the generation OF MANUFACTURING FRAME DESIGNS, and filed on Nov. 5, 2003.

### FIELD OF THE INVENTION

In general, the present invention relates to computer software and manufacturing, and in particular, to a system and method for automating the generation of manufacturing frame designs.

### BACKGROUND OF THE INVENTION

Generally described, the manufacture of vehicles, especially large commercial vehicles, can require a specification of a number of components that are to be included with the vehicle. In many instances, a purchaser, or designer, can select from a number of options for each component to be included in the vehicle. For example, a purchaser may have the ability to select from more than a half dozen variations of fuel tank components for a commercial truck. In turn, each specified component can correspond to one or more pieces of geometry that make up the component. For example, a fuel tank component can include one piece of geometry that corresponds to the tank, two or more pieces of geometry that correspond to straps/brackets for mounting the tank and a number of additional pieces of geometry that correspond to mounting bolts that attach the tank to the straps/brackets and that attach the straps/brackets to the frame. As the number of component options increase, the design of the vehicle, often referred to as a frame design, becomes customized.

One traditional approach to customized frame designs requires the utilization of design engineers that receive specifications of components for new vehicles and generate the corresponding customized frame designs. In this approach, the customized frame design is created manually, often with the assistance of various computer aided design (CAD) or other graphics programs. The manual frame design approach requires the design engineer to individually place each piece of geometry in a specified component to avoid any interference between components. Although this approach typically results in customized frame designs, it can be time consuming and expensive to utilize design engineers to manually create the frame designs.

Another approach to customize frame designs involves the utilization of some automated systems for configuring the location of the components on a vehicle frame. In one embodiment, computing systems have been developed with hundreds of thousands of processing rules that attempt to configure locations for each piece of geometry in specified components. The processing rules attempt to account for every possible configuration of component for a vehicle. Although this approach attempts to facilitate the automation of the generation of frame designs, this approach can be limited in requiring an expansive amount of processing rules. Further, this approach also requires a great deal of up front processing time to incorporate new components or new combinations of existing components.

In another embodiment for automating the configuration of the location of components on a vehicle frame, computing systems have been developed with a smaller subset of processing rules that allow the computing system to determine the most appropriate location for system components. To select an appropriate location for a component (e.g., the pieces of geometry corresponding to the component), this approach requires an increased ability for the computer system to identify possible interferences between system components. However, current implementations of this approach are rudimentary in nature in not being able to accurately determine when interferences between configured components will occur. Accordingly, design engineers are still required to configure a large portion of the frame design that the automated computing system cannot configure.

Thus, there is a need for a system and method for automating the generation of manufacturing frame designs with improved interference checking and component configuration.

### SUMMARY OF THE INVENTION

A system and method for automating the generation of manufacturing frame designs are provided. A frame design processing server includes a plurality of modules for generating frame designs. The frame design processing server obtains a specification of components for a vehicle and processes the specification according frame design rules and three-dimensional representations of each piece of component geometry. The frame design processing server configures positions for the each of the specified components based upon processing data in the frame design rules and based upon conducting interference checks. The resulting configuration can be exported as manufacturing data and/or three-dimensional representations of the frame design.

In accordance with an aspect of the present invention, a method for generating frame designs for manufacturing a vehicle is provided. In accordance with the method, a frame design processing server obtains a specification of one or more components to be mounted on a frame of a vehicle. The frame design processing server obtains processing data corresponding to each of the one or more components to be mounted on the frame of the vehicle. The processing data includes location information corresponding to a logical starting position for attempting to locate a component on the frame and a range of additional positions to locate the component. The processing data also includes three-dimensional data corresponding to a tessellated representation of the component. The frame design processing server then selects a component of the one or more components and sets a current position as the starting position in the processing data. The frame design processing server determines whether the tessellated representation of the selected component located at the current position interferes with the tessellated representation of any other components already configured to the frame. If an interference occurs, the a frame design processing server sets a next position in the range of additional positions defined in the processing data as the current position and repeats the process. If no interference occurs, the frame design processing server configures the position of the selected component as the current position. The frame design processing server then repeats the entire process for any remaining components of the one or more components. Once all of the components have been configured, the frame design processing server generates a frame design corresponding to the configured positions for each of the one or more components.

In accordance with another aspect of the present invention, a method for generating frame designs for manufacturing a vehicle is provided. In accordance with the method, a frame design processing server obtains a specification of one or more components to be mounted on a frame of a vehicle. The frame design processing server also obtains processing data corresponding to each of the one or more components to be mounted on the frame of the vehicle. The processing data includes location information corresponding to a logical starting position for attempting to locate a component on the frame and a range of additional dimensional positions to locate the component. The processing data also includes three-dimensional data corresponding to a tessellated representation of the component. The frame design processing server enters an iterative loop by selecting a component of the one or more components and setting a current position as the starting position in the processing data. The frame design processing server configures a position for the selected component based upon conducting an interference check corresponding to comparison of a tessellated representation of the selected component interferes with the tessellated representation of any other components already configured to the frame. The frame design processing server repeats the process for any remaining components of the one or more components. Once the components have been configured, the frame design processing server generates a frame design corresponding to the configured positions for each of the one or more components.

In accordance with a further aspect of the present invention, a computer-readable medium having computer-executable modules for generating frame designs for manufacturing a vehicle is provided. The computer-executable modules include an interface module for obtaining a specification of one or more components to be mounted on a frame of a vehicle and for transmitting a frame design corresponding to a configuration of the components mounted on the frame of the vehicle. The computer-executable modules also include a processing data module for storing processing data corresponding to each of the one or more components to be mounted on the frame of the vehicle. The processing data includes location information corresponding to a logical starting position for attempting to locate a component on the frame and a range of additional positions to locate the component. The processing data also includes three-dimensional data corresponding to a tessellated representation of the component. The computer-executable modules further include a configuration module for configuring a location for a selected component of the one or more components to be mounted on a frame of a vehicle based upon an interference check corresponding to comparison of a tessellated representation of the selected component interferes with the tessellated representation of any other components already configured to the frame.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a frame design processing system for generating customized frame design and manufacturing data in accordance with the present invention;

FIG. 2 is a block diagram of the frame design processing system of FIG. 1 illustrating the interaction of a frame design processing server with external clients and external information sources in accordance with the present invention;

FIG. 3 is a block diagram of the frame design processing system of FIG. 2 illustrating the generation of frame design rules and component templates and the initiation on of a custom truck specification in accordance with the present invention;

FIG. 4 is a block diagram of the frame design processing system of FIG. 2 illustrating the processing of the custom truck specification in accordance with the present invention;

FIG. 5 is a block diagram of the frame design processing system of FIG. 2 illustrating the generation and exportation of the custom frame design and manufacturing data in accordance with the present invention;

FIG. 6 is a flow diagram illustrative of a frame design processing routine implemented by a frame design processing server in accordance with the present invention;

FIG. 7 is a flow diagram illustrative of a frame design generation sub-routine implemented by a frame design processing server in accordance with the present invention;

FIG. 8 is a flow diagram illustrative of a hole matching sub-routine implemented by a frame design processing server in accordance with the present invention;

FIG. 9 is a block diagram of a portion of a tree structure illustrating various branch hierarchies and leaf node sets of component data in accordance with the present invention;

FIG. 10 is a block diagram of a screen interface for defining various types of processing data for a manufacturing component;

FIG. 11 is a block diagram of a screen display illustrative of a three-dimensional representation of a manufacturing component in accordance with the present invention; and

FIG. 12 is a block diagram of a screen display illustrative of a frame design representation including a plurality of manufacturing components in accordance with the present invention.

### DETAILED DESCRIPTION OF THE PREFERRED EMBODIMENT

As described above, aspects of the present invention may be embodied in a WWW or Web site accessible via the Internet. As is well known to those skilled in the art, the term “Internet” refers to the collection of networks and routers that use the Transmission Control Protocol/Internet Protocol (“TCP/IP”) to communicate with one another. The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive communication environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the web server itself.

A remote access user may retrieve hypertext documents from the World Wide Web via a Web browser program. A Web browser, such as Netscape's NAVIGATOR® or Microsoft's Internet Explorer, is a software application program for providing a user interface to the WWW. Upon request from the remote access user via the Web browser, the Web browser requests the desired hypertext document from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

Generally described, the present invention relates to a system and method for automating manufacturing frame designs. More specifically, the present invention relates to a system and method for automating the generation of frame design data through the utilization of various automation modules. The generation of the frame design data can correspond to the specification of location information for a number of selected components to be mounted to a frame. Each specified component can correspond to one or more pieces of geometry that have been associated with the component. Although the present invention will be described and illustrated with vehicle frame designs, such as for a customized truck, one skilled in the relevant art will appreciate that the disclosed embodiments are illustrative in nature and should not be construed as limiting.

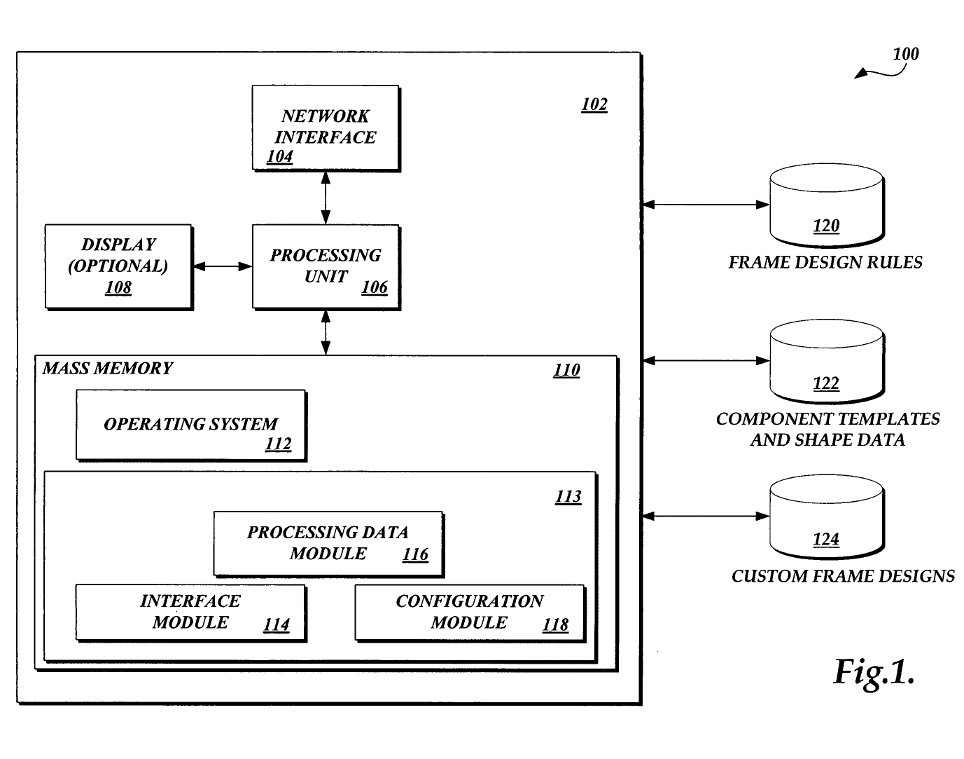

FIG. 1 is a block diagram illustrative of a frame design processing system 100 for generating frame design data in accordance with the present invention. The frame design data can include data to facilitate the manufacture of a vehicle. Additionally, the frame design data can include data to generate an illustration of the configured vehicle. The frame design processing system 100 includes a frame design processing server 102 for generating customized truck frame designs and manufacturing data. As illustrated in FIG. 1, the frame design processing server architecture can include various components. However, one of ordinary skill in the art will appreciate that the frame design processing server 102 includes many more components than those shown in FIG. 1. However, it is not necessary that all of these generally conventional components be shown in order to disclose an illustrative embodiment for practicing the present invention.

As shown in FIG. 1, the frame design processing server 102 includes a network interface 104 for connecting directly to a local area network (LAN) or wide area network (WAN), or for connecting remotely to a LAN or WAN. Those of ordinary skill in the art will appreciate that the network includes the necessary circuitry for such a connection, and is also constructed for use with the TCP/IP protocol, the particular network configuration of the LAN or WAN it is connecting to, and a particular type of coupling medium. The frame design processing server 102 may also be equipped with a modem for connecting to the Internet through a point-to-point protocol (“PPP”) connection or a serial-line Internet protocol (“SLIP”) connection as known to those skilled in the art.

The frame design processing server 102 also includes a processing unit 106, an optional display 108, and a mass memory 110, all connected via a communication bus, or other communication device. The mass memory 1 10 generally comprises a RAM, ROM, and a permanent mass storage device, such as a hard disk drive, tape drive, optical drive, floppy disk drive, or combination thereof. The mass memory 110 stores an operating system 112 for controlling the operation of the frame design processing server 102. It will be appreciated that this component may comprise a general-purpose server operating system as is known to those skilled in the art, such as UNIX, LINUX™, or Microsoft WINDOWS 2000®.

The mass memory 110 also stores program code and data for processing a customized truck specification and generating frame design and manufacturing data. More specifically, the mass memory 110 stores a frame design application 113 that can include various modules for implementing various functions. As illustrated in FIG. 1, the frame design application 113 can include an interface module 114 for obtaining specifications for vehicle components to be mounted on the frame and for exporting the completed frame design. The frame design application 113 can also include a processing module 116 for storing processing data corresponding to the components to be mounted on to the vehicle. Further, the frame design application 113 can include a configuration module 118 for configuring a location for the modules to be mounted on the vehicle. It will be appreciated that these components may be stored on a computer-readable medium and loaded into the memory of the frame design processing server 102 using a drive mechanism associated with the computer-readable medium, such as a floppy, CD-ROM, DVD-ROM drive, or network drive 104.

As also illustrated in FIG. 1, the frame design processing server 102 is in communication with a number of data repositories for use in the processing of custom vehicle specifications. The data repositories include a frame design rules database 120 for storing configuration rules for various three-dimensional components to be added to a frame design. The data repositories also include a component templates and shape data database 122 for storing three-dimensional geometric representations for the display and configuration of various three-dimensional components to be added to a frame design. As described above, each component can correspond to one or more individual pieces of geometry that are associated with a specific component. The data repositories further include a custom frame design database 124 for storing processed, custom frame designs. Although the data sources are illustrated as external to the frame design processing server 102, one skilled in the relevant art will appreciate that one or more of the data repositories may be integrated within the frame design processing server. Further, one or more of the data repositories may be distributed among several computing devices or within a network of computing devices.

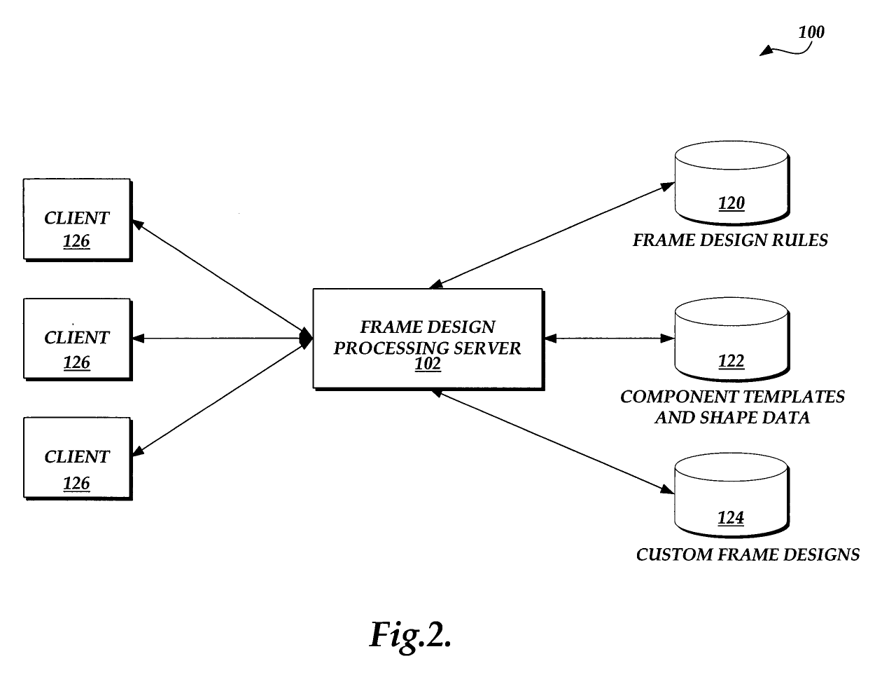

With reference now to FIGS. 2-5, the frame design processing server 102 may be utilized in a networked embodiment for generating designs and manufacturing data from a specification of components to be mounted on the frame of a vehicle. With reference to FIG. 2, in an illustrative embodiment of the present invention, the frame design processing system 100 includes one or more client computing devices 126 that are operable to interface with the frame design processing server 102. The client computing devices 126 transmit to the frame design processing server 102 the specification of components to be mounted on the vehicle. In turn, the frame design processing server 102 utilizes information from the frame design rules database 120 and the component templates and shape data database 122 to process the request and generate a frame design for a vehicle.

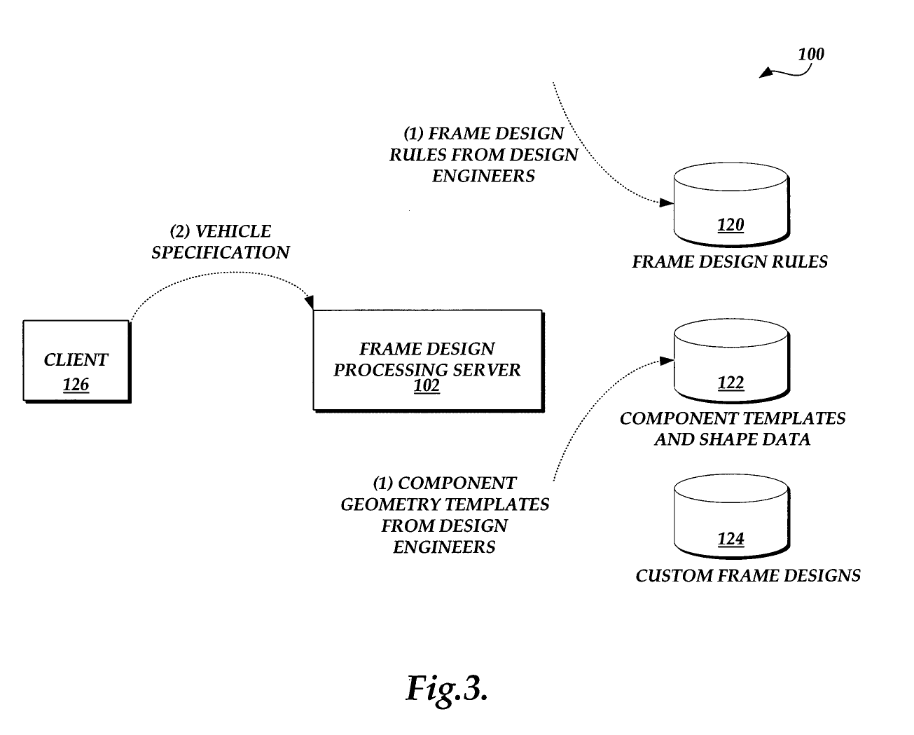

With reference now to FIG. 3, to initiate the process, the frame design processing system 100 obtains frame design rules and component geometry templates from one or more sources, such as a design engineer. In an illustrative embodiment of the present invention, the generation and storage of the frame design rules and component geometry templates can be completed with the initialization of the frame design processing system 100. Further, the frame design rules and component geometry templates can be further updated or modified at any time during the operation of the frame design processing system 100. Once the requisite data is stored in the frame design rules and component geometry templates databases 120, 122, the frame design processing server 102 obtains a request from a client 126 that includes a specification of one or more components to be included in a frame design of a vehicle.

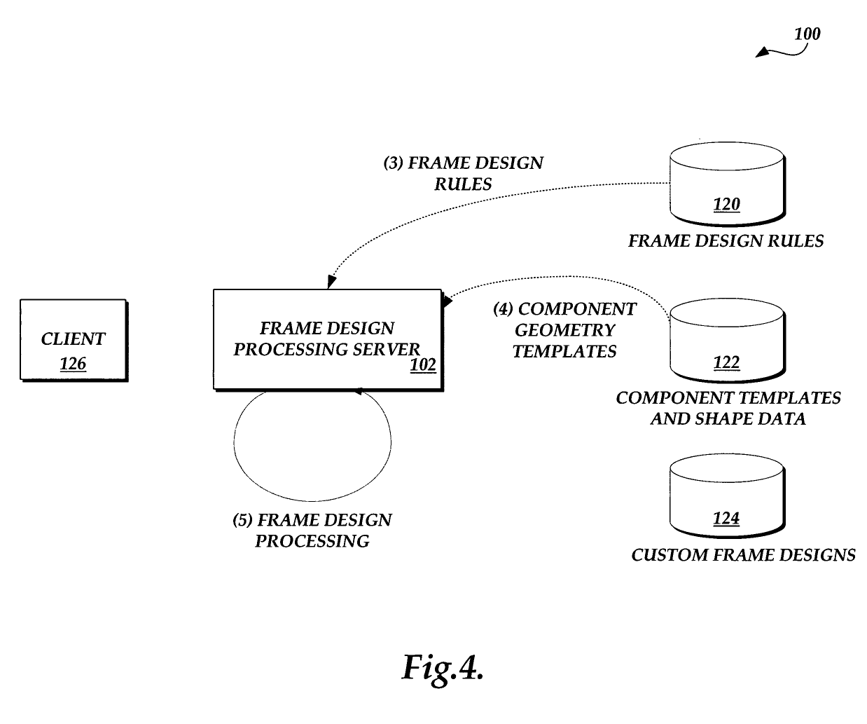

With reference to FIG. 4, the frame design processing server 102 identifies the listed components in the specification and obtains frame design rules and component templates and shape data for each of the listed components. The frame design processing server 102 then processes the specification according to the specific frame design rules and component templates to configure a location for each of the components to be mounted onto the frame. In an illustrative embodiment of the present invention, the configuration of the components corresponds to a selection of a location for each of the pieces of geometry corresponding to the selected component on the frame of the vehicle. The location for each piece of geometry of the selected component is selected such that the pieces do not interfere with any other configured pieces of geometry. Further, the location for each piece of geometry corresponding to the selected component is selected such that the location of the pieces is within an acceptable range of locations for the geometry pieces as defined in the frame design rules.

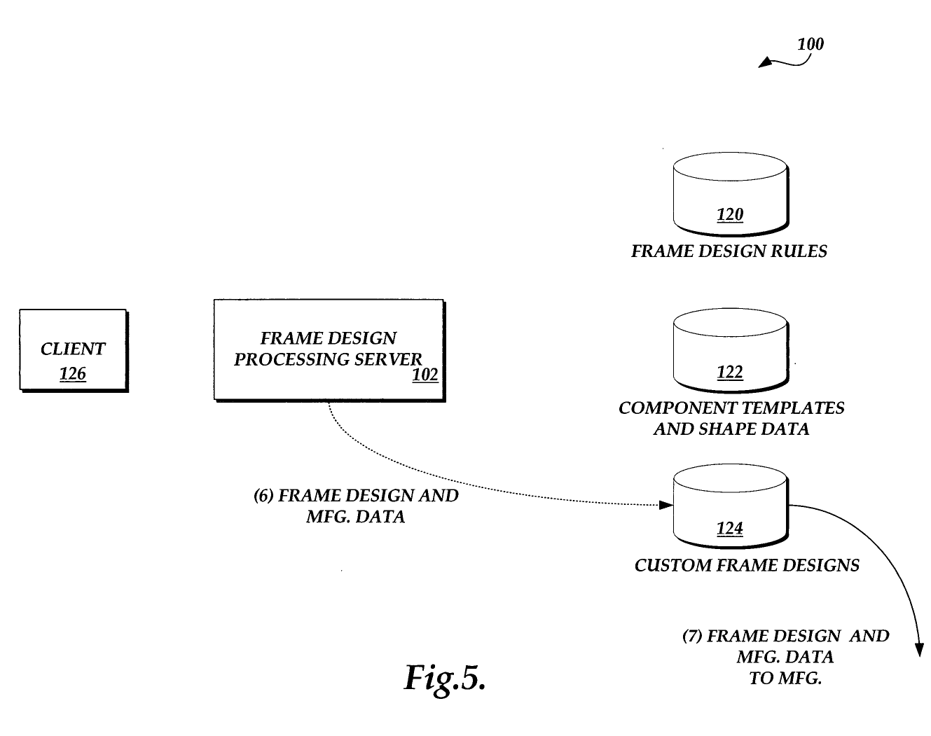

With reference now to FIG. 5, once the specification has been processed to generate the frame design, the frame design processing server 102 exports frame design data to custom frame design database 124. In an illustrative embodiment of the present invention, the frame design data can correspond to data to be provided to a manufacturer, such as a data file defining the selected frame component configurations and hole locations for the selected components. Additionally, the frame design data can correspond to data that corresponds to a three-dimensional representation of the vehicle configured with the components from the specification. The resulting frame data can be exported to any number of additional parties.

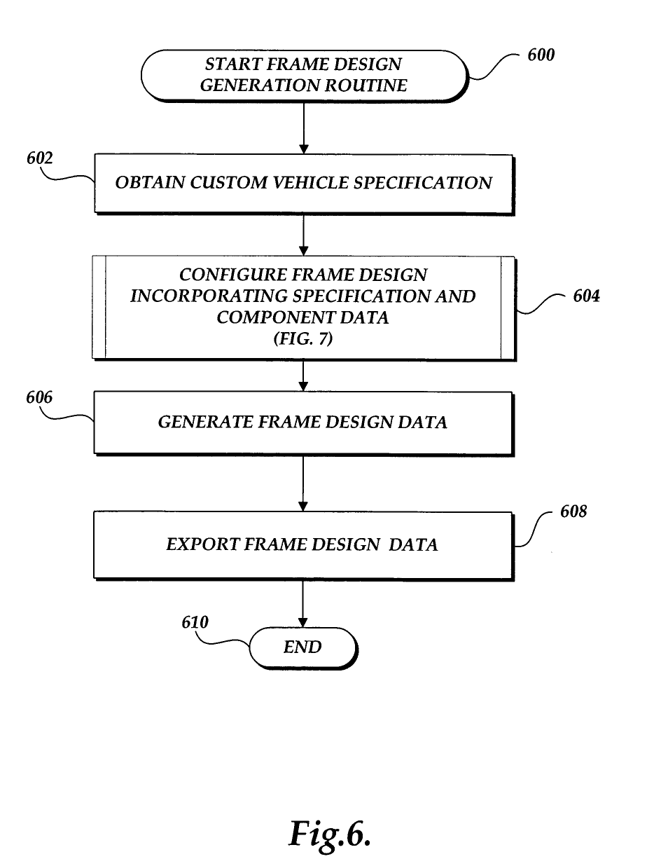

FIG. 6 is a flow diagram illustrative of a frame design data generation routine 600 implemented by the frame design processing server 102 in accordance with the present invention. At block 602, the frame design processing server 102 obtains a vehicle specification. In an illustrative embodiment of the present invention, as illustrated in FIG. 3, a client computing device 126 transmits a vehicle specification to the frame design processing server 102 via a network connection. For example, the client computing device 126 can correspond to a networked computing device at a vehicle dealer that allows customers to selects components to be included in a vehicle purchase. Alternatively, the vehicle specification may be generated by a computing device that automatically allocates components to be included in new vehicle manufacture. Further, although the specification is illustrated as being computer generated, one skilled in the relevant art will appreciate that alternative forms of communication and data entry, such as telephone and fax, may also be utilized in the present invention.

At block 604, the frame design processing server 102 configures a location for the pieces of geometry corresponding to the specified components. The configuration of component locations for a frame design will be described in greater detail below. At block 606, the frame design processing server 102 generates frame design data and exports the data at block 608. In an illustrative embodiment of the present invention, the format of the frame design data will correspond to a particular function for the data. In one aspect, the frame design data can include manufacturing data for use in the manufacture of the vehicle. The manufacturing data can be in the form of a textual file including an identification of all components to be mounted on a frame and dimensional data corresponding to a configured location for each piece of geometry associated with the selected components. In another aspect, the frame design data can include visual data for representing the configured vehicle. The visual data can include two and three-dimensional data for displaying the configuration of the components to mounted on the frame of the vehicle. The frame design data can be exported directly to one or more external sources. Additionally, the frame design data can be exported to the custom frame design database 124 for storage. At block 610, the routine 600 terminates.

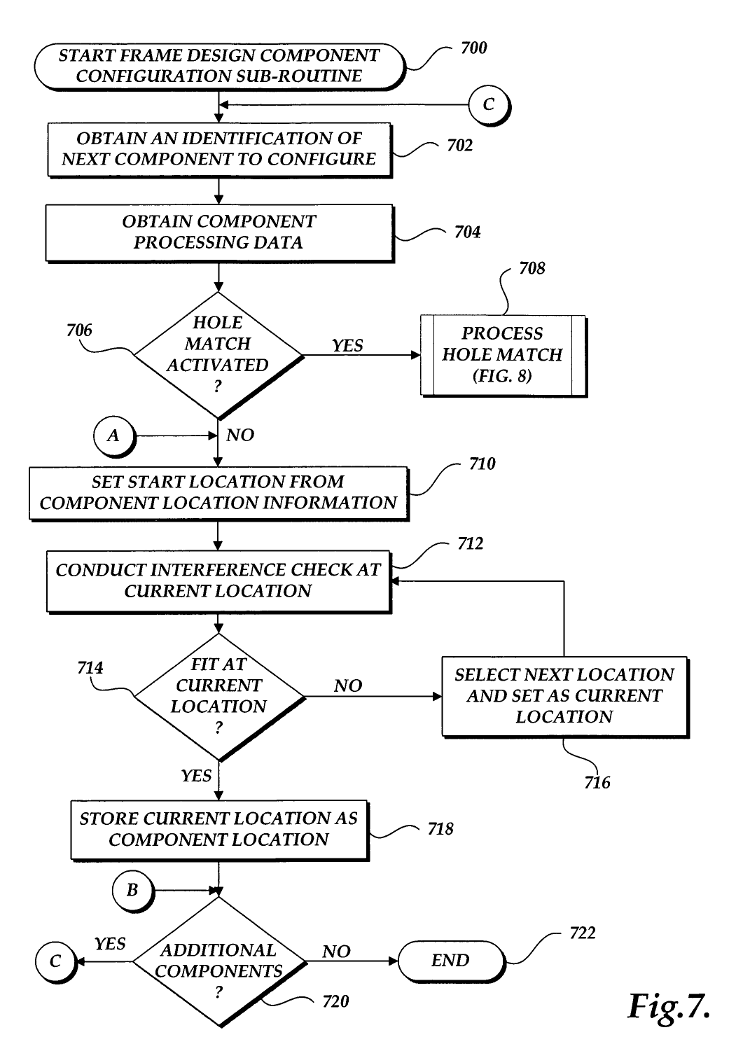

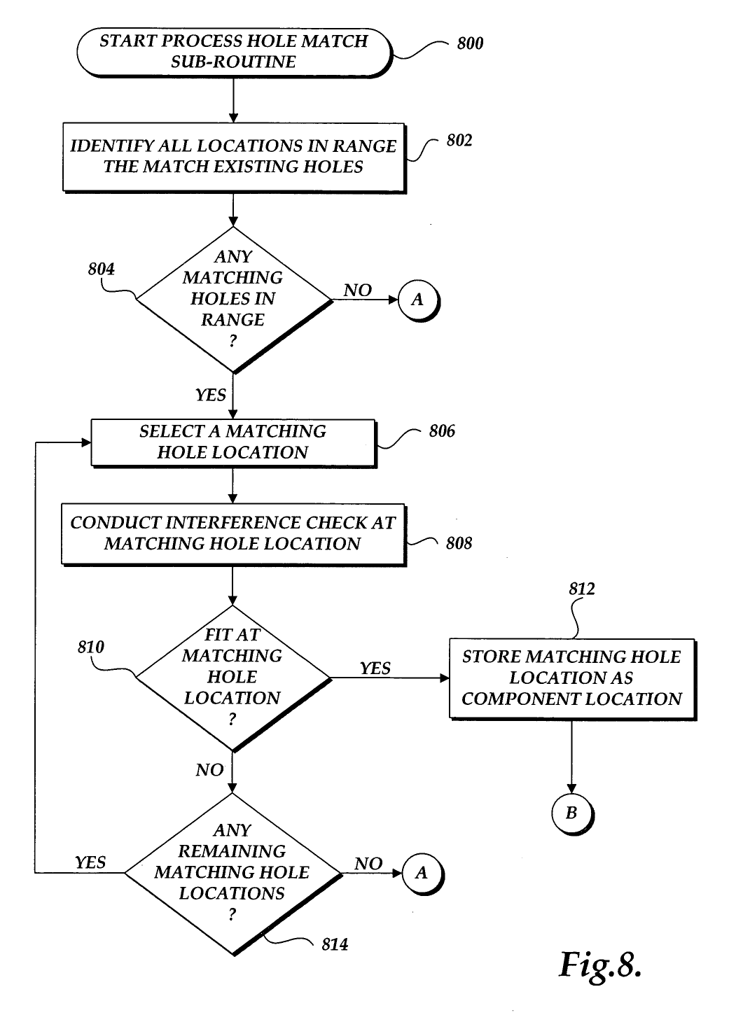

With reference now to FIGS. 7 and 8, sub-routines 700 and 800 corresponding to block 604 (FIG. 6) for processing frame designs will be described. With reference to FIG. 7, the frame design component configuration sub-routine 700 begins an iterative loop for configuring the components at block 702 by obtaining an identification of the next component to configure. In an illustrative embodiment of the present invention, the identification of the components to be added to the frame may be based upon an order provided in the specification. Additionally, the identification of the components to be added to the frame may be based upon a grouping of one or more components based upon relationships defined for those components. Accordingly, the identification of the next component to be configured can be based on a selection of the next component in an ordered list.

At block 704, the frame design processing server 102 obtains component processing data for the selected component. In an illustrative embodiment of the present invention, the frame design processing server 102 selects component processing data by traversing a tree structure that defines various sets of component processing data for various components. Each branch node within the tree structure represents different levels of organizational hierarchies for the components and their processing data. Additionally, leaf nodes within the tree structure represent one or more sets of processing data that may be used by the frame design processing server 102 for a selected component. Although the present invention will be described with regard to an illustrative tree structure, one skilled in the relevant art will appreciate that tree structure is illustrative and should not be construed as limiting.

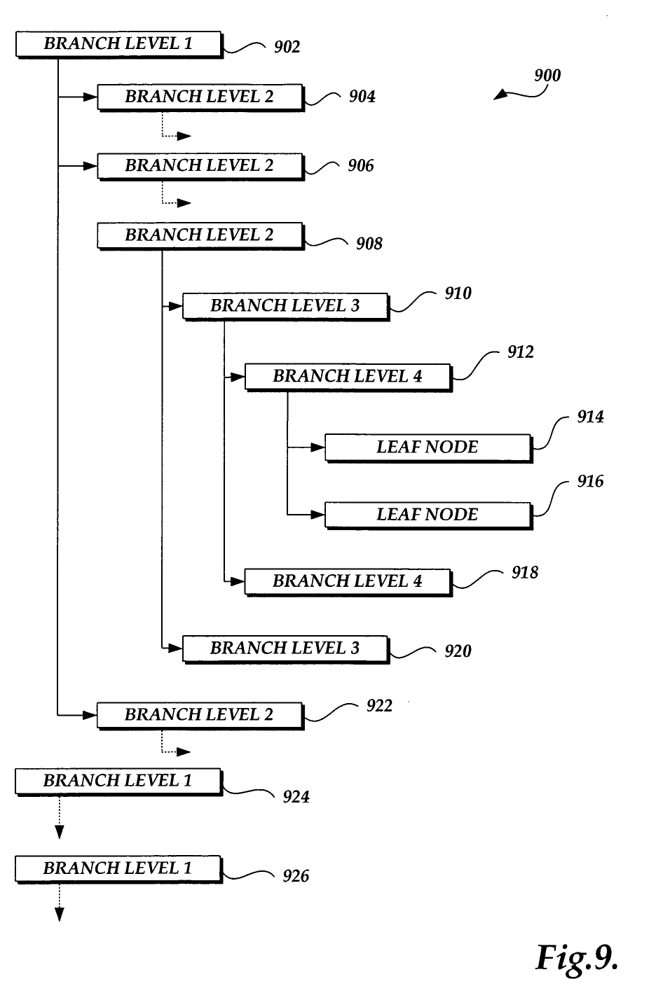

FIG. 9 is a block diagram of a portion of a tree structure 900 illustrating various branch hierarchies and leaf node sets of component data in accordance with the present invention. As illustrated in FIG. 9, the tree structure 900 includes multiple levels of branch nodes corresponding to various organization hierarchies for the components. A first level of the tree structure, represented by branch nodes 902, 924 and 926, corresponds to the highest level of organization for the components. For example, the highest level of organization can correspond to distinct classes of components, such as fuel tanks, battery boxes, etc. A second level of the tree structure, represented by branch nodes 904, 906, 908 and 922, is linked to first branch node 902 and define a second level of organization for the components in the first branch node. For example, the second level of organization can correspond to various implementations of a component class, such as 50-gallon fuel tank, 35-gallon fuel tank, etc.

As illustrated in FIG. 9, a third and fourth level of the structure 900, represented by nodes 910, 912, 918, and 920 correspond to further configuration parameters of the components specified at the second level. For example, the third level nodes can correspond to choice between steel and aluminum tanks, while the fourth level nodes correspond to particular diameters for each material. The final level of the tree structure 900, represented by leaf nodes 914 and 916 defines alternative sets of processing data for the components in the second branch node 908, with the specifications identified by nodes 910 and 912. As described above, the leaf nodes identify the component processing data that can be used to configure a selected component. As illustrated in FIG. 9, leaf nodes 914 and 916 indicate that two possible sets of component processing data that may be utilized to configure a particular component.

With continued reference to FIG. 9, in an illustrative embodiment of the present invention, the frame design processing server 102 selects the first leaf node corresponding to a selected component (e.g., leaf node 914) and attempts to configure the pieces of geometry corresponding to the selected component with the component processing data identified by the leaf node. If the configuration fails, the frame design processing server 102 selects the next leaf node (e.g., leaf node 916) corresponding to the selected component and attempts to configure the pieces of geometry corresponding to the selected component with the component processing data corresponding to the leaf node. The frame design processing server 102 can continue selecting leaf nodes in attempt to configure the component to the frame. Accordingly, a particular component may correspond to multiple sets of processing data.

In an illustrative embodiment of the present invention, the component processing data selected from one of the leaf nodes can include an identification of all the geometry pieces associated with a selected component. For example, each component can include a piece for of geometry for a part (e.g., specific capacity fuel tank) and any additional pieces of geometry required to mount the part to the frame (e.g., brackets, bolts, etc.). The component processing data can also include location information for defining a starting location for locating each piece of geometry associated with the component on the frame of the vehicle, a range of additional positions to locate the geometry, three-dimensional tessellation data representative of each piece of geometry, and any additional rules or component associations. One skilled in the relevant art will appreciate that different components for a vehicle, and their associated pieces of geometry, may have specific limitations as to their location on the vehicle. In one aspect, the starting position may be provided as a directional dimension, such as an offset in one or more axis, from a reference point on the frame itself. In another aspect, the starting position may be provided as a directional dimension, such as an offset in one or more axis, from another component that may be configured on the frame. The range of additional positions may also be specified as a dimensional dimension in one or more directions from the starting location. Further, the range of additional positions may specify a preferred direction for searching for the additional locations. In an illustrative embodiment of the present invention, the different sets of component processing data can include different configuration information for pieces of geometry and/or an identification of different pieces of geometry that correspond to the selected component.

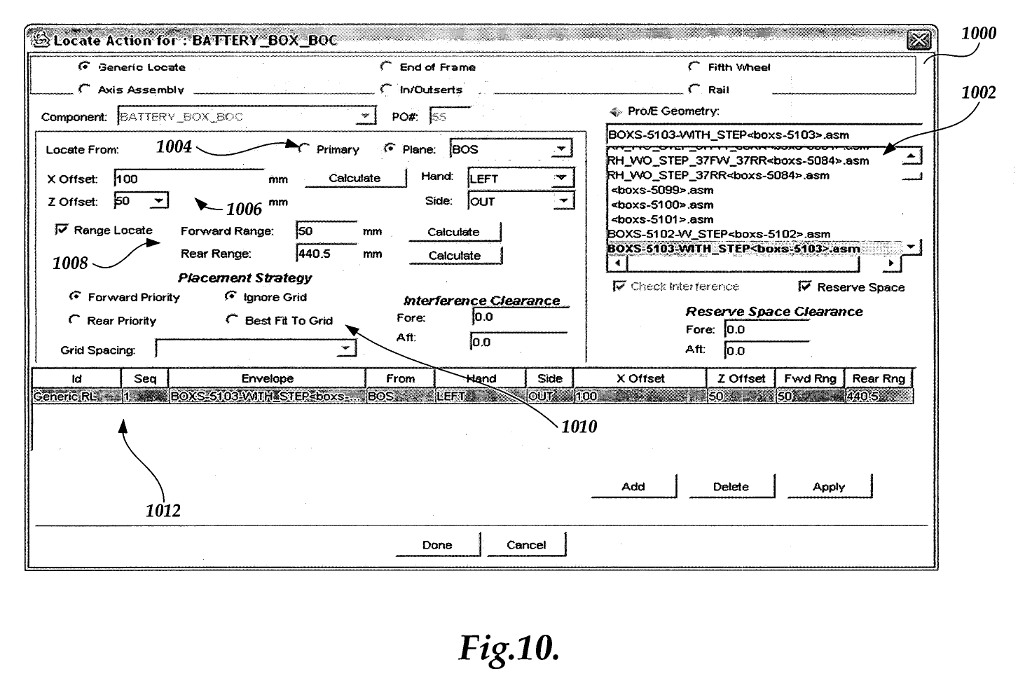

FIG. 10 is a block diagram of a screen interface 1000 for defining various types of processing data for a manufacturing component in accordance with the present invention. As described above, the generation of the frame design rules may take place prior to the initiation of the frame design processing routine 600 and may be provided by external third parties. As illustrated in FIG. 10, the screen interface 1000 corresponds to a specification of the location properties for a given component. The location properties can be associated with a specific three-dimensional component geometry in field 1002. The location properties can also include a series of input for specifying the location attributes the frame design processing server 102 will use to locate the component. More specifically, the inputs can include a selection of a reference point 1004 for the starting location and an offset 1006 from the selected reference point. The inputs also include a range specification including dimensional dimensions 1008 and placement strategies 1010. As illustrated in FIG. 10, the screen display 1000 can also include an identification 1012 of all the pieces of geometry that correspond to the selected component.

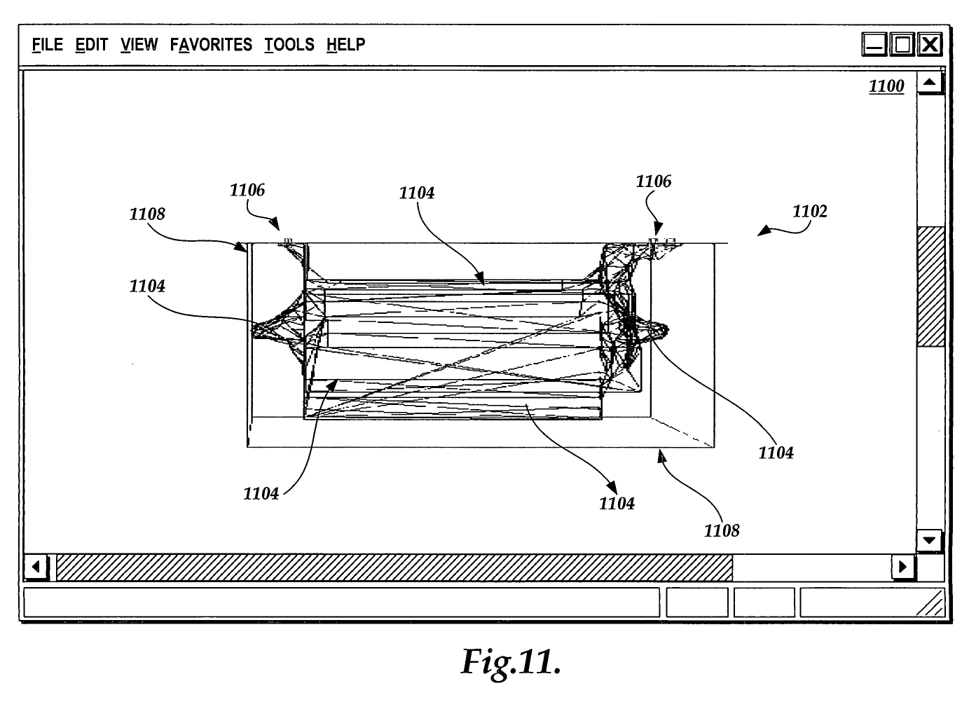

Returning to FIG. 7, in additional to the location information, the component processing data also includes three-dimensional data corresponding to a tessellated representation of each piece of geometry corresponding to a selected component. The tessellated representation of the component defines the outer surfaces of the components for purposes of detecting any interference with other configured components. In an illustrated embodiment of the present invention, the tessellated representation is achieved by modeling the outer surfaces of an object as a series of triangular shaped planes. FIG. 11 is a block diagram of a screen display 1100 illustrative of a three-dimensional representation of a manufacturing component 1102 in accordance with the present invention. As illustrated in FIG. 11, the component is represented as a series of tessellation planes 1104 that define each portion of an outer surface of a first piece of geometry corresponding to the component. The component is also represented as a series of tessellation planes 1106 that correspond to another piece of geometry corresponding to the component. Additionally, the outer boundaries of the component can also be represented by a rectangular box representation 1108. Although the tessellation is represented as triangular planes, one skilled in the relevant art will appreciate that a variety of geometric shapes may be utilized to model all or a portion of a component geometry.

Returning again to FIG. 7, at decision block 706, a test is conducted to determine whether a hole matching feature is activated. In an illustrative embodiment of the present invention, the hole matching feature allows the frame design processing server 102 to select a location for the selected pieces of geometry corresponding to the selected component on the frame to match with one or more preexisting holes on the frame. If the hole matching feature is activated, the frame design processing server 102 processes the hole match at block 708, which will be described in greater detail below.

If the hole matching feature is not activated, at block 710, the frame design processing server 102 sets the start location from the processing data as a potential current location for the component and at block 712, determines whether there is an interference with any configured components at the current location. In an illustrative embodiment of the present invention, the determination of an interference relates to a determination whether any of the tessellation planes of the selected pieces of geometry corresponding to the component intersect with the tessellation planes of any other configured components. If an intersection occurs, the components interfere. Further, the determination of an interference also relates to a determination of whether a component has been placed entirely within another component (assuming that the planes do not intersect).

In an illustrative embodiment of the present invention, to detect whether an interference occurs, a ray is generated from the center of origin of the selected component. If the ray intersects any configured components an even number of times, that indicates that the ray has passed through the configured component and the selected component is not placed within that component. If the ray intersects any configured components an odd number of times, that indicates that the ray has only passed through only one surface of the configured component and the selected component has been placed within that component. One skilled in the relevant art will appreciate that additional or alternative tests for interfering components may also be practiced with the present invention.

At decision block 714, a test is conducted to determine whether the selected pieces of geometry corresponding to the selected component will fit in the current position based on the interference check at block 712. If the selected component will not fit, at block 716, the frame design processing server 102 selects the next location in the possible range of locations and sets the next location as the current location. The sub-routine 700 returns to block 712 for an interference check for the newly assigned location. In an illustrative embodiment of the present invention, the frame design processing server 102 can select the next position by reviewing the location properties of the selected component that can dictate a dimensional measurement and a preferred direction for selecting the next location. The frame design processing server 102 can proceed along pre-determined increments or at increments defined in the frame design processing rules. Additionally, the frame design processing server 102 may proceed at increments defined by the interference check (block 712). Further, as discussed above, in an illustrative embodiment of the present invention, in the event that none of the locations within the location properties will work, the frame design processing server 102 can select any subsequent sets of component processing data as defined in the rule tree structure.

With reference again to decision block 714, if the pieces of geometry are found to fit at the selection, at block 718, the frame design processing server 102 stores the current location of the selected component as the component location on the frame. This location will be used to check for interference with subsequently selected components. At decision block 720, a test is conducted to determine whether any additional components are to be included in the frame design. If so, the sub-routine 700 returns to block 702, as described above. If no additional components are to be included in the frame design, the sub-routine 700 returns at block 722.

With reference now to FIG. 8, a sub-routine 800 for processing an existing hole match will be described. At block 802, the frame design processing server 102 identifies all locations within the range of possible locations for the component that match existing holes in the frame. In an illustrative embodiment of the present invention, the range of possible locations is defined in the component processing data selected for the component. At decision block 804, a test is conducted to determine whether any existing holes on the frame are found within the range of possible locations for the component. If no existing holes are within the range, the sub-routine 800 returns to block 710 (FIG. 7), where the frame design processing server 102 utilizes the component processing data to select a location for the component.

If one or more existing holes are within the range, at block 806, the frame design processing server 102 selects a first location that includes matching hole locations. In an illustrative embodiment of the present invention, the frame design processing server 102 scans the entire range of possible locations and identifies all possible locations having at least one matching hole location. In the event there are multiple locations that match existing holes, the frame design processing server 102 selects the location that includes the most matching holes. In the event that there are multiple locations having the same number of matching holes, the frame design processing server 102 can utilize additional criteria to select the matching hole. For example, the frame design processing server 102 can select the matching hole location closest to the start location indicated in the component processing data.

At block 808, the frame design processing server 102 conducts an interference check for the selected component at a matching hole location. In an illustrative embodiment of the present invention, the interference check is conducted in a similar manner to the interference check described with regard to block 712 (FIG. 7). At decision block 810, a test is conducted to determine whether the selected component will fit in the position based on the interference check at block 808. If no interference is detected, at block 812, the frame design processing server 102 stores the location of the matching hole as the component location on the frame. This location will be used to check for interference with subsequently selected components. Alternatively, if an interference is detected, at decision block 814, a test is conducted to determine whether additional locations with matching holes exist. If additional locations with matching holes exist, the sub-routine 800 returns to block 806. Alternatively, if no additional locations with matching holes exist, the sub-routine 800 returns to block 710 (FIG. 7), here the frame design processing server 102 utilizes the component processing data to select a location for the component.

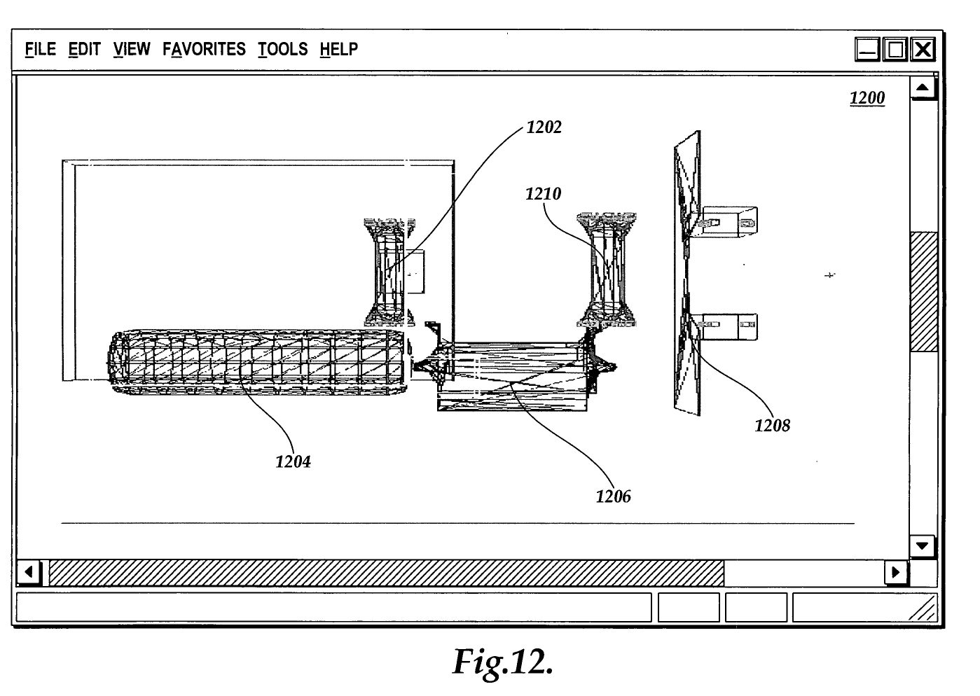

FIG. 12 is a block diagram of a screen display 1200 illustrative of a frame design representation including a plurality of manufacturing components in accordance with the present invention. As illustrated in FIG. 12, the screen display includes multiple tessellated representations 1202, 1204, 1206, 1208 and 1210 of components that have been configured to the frames of a vehicle. Data corresponding to the precise location of the configured components will be transmitted for manufacture. Further, the three-dimensional data of the configured components will be utilized to check for interference in subsequently selected components.

While illustrative embodiments of the invention have been illustrated and described, it will be appreciated that various changes can be made therein without departing from the spirit and scope of the invention.

1. A method for generating frame designs for manufacturing a vehicle, the method comprising:
(a) obtaining a specification of one or more components to be mounted on a frame of a vehicle,
(b) obtaining processing data corresponding to each of the one or more components to be mounted on the frame of the vehicle, wherein the processing data includes location information corresponding to a logical starting position for attempting to locate a component on the frame and a range of additional positions to locate the component and three-dimensional data corresponding to a tessellated representation of the component;
(c) selecting a component of the one or more components and setting a current position as the logical starting position in the processing data;
(d) determining whether the tessellated representation of the selected component located at the current position interferes with the tessellated representation of any other components already configured to the frame;
(e) if an interference occurs, setting a next position in the range of additional positions defined in the processing data as the current position and repeating (d);
(f) if no interference occurs, configuring the position of the selected component as the current position;
(g) repeating (d)-(f) for any remaining components of the one or more components; and
(h) generating a frame design corresponding to the configured positions for each of the one or more components.

2. The method as recited in claim 1, wherein determining whether the tessellated representation of the selected component located at the current position interferes with the tessellated representation of any other components already configured to the frame includes iteratively comparing whether any tessellated planes within the three-dimensional data of the selected component intersect with any tessellated planes with the three-dimensional data of any components already configured to the frame.

3. The method as recited in claim 1, wherein determining whether the tessellated representation of the selected component located at the current position interferes with the tessellated representation of any other components already configured to the frame includes determining whether the selected component located at the current position is located within another configured component.

4. The method as recited in claim 1, wherein obtaining a specification of one or more components to be mounted on a frame of a vehicle includes obtaining a list of required components from a user interface.

5. The method as recited in claim 1, wherein the logical starting position corresponds to a dimensional measurement relative to the frame.

6. The method as recited in claim 1, wherein the logical starting position corresponds to a dimensional measurement relative to another component.

7. The method as recited in claim 1, wherein the range of additional positions to locate the component includes a maximum dimensional measurement in a first direction from the logical starting position.

8. The method as recited in claim 7, wherein the range of additional positions to locate the component includes a maximum dimensional measurement in a second direction from the logical starting position.

9. The method as recited in claim 1, wherein prior to configuring the position of the selected component, the method further comprising:
determining whether the selected component fits with any existing holes on the frame for attaching a component at the current location;
if the selected component does fit with any existing holes on the frame for attaching a component, determining whether the tessellated representation of the selected component located at a position corresponding to a matching hole interferes with the tessellated representation of any other components already configured to the frame;
if no interference occurs, configuring the position of the component as the position corresponding to a matching hole.

10. The method as recited in claim 1, wherein each of the one or more components corresponds to one or more pieces of geometry.

11. The method as recited in claim 1, wherein obtaining processing data corresponding to one or more components includes traversing a tree structure to select a set of processing data.

12. The method as recited in claim 11, wherein the tree structure includes two or more sets of processing data for a selected component and wherein setting a next position in the range of additional positions defined in the processing data includes selecting a new set of processing data and obtaining a next position.

13. The method as recited in claim 1, wherein generating a frame design corresponding to the configured positions for each of the one or more components includes generating a three-dimensional representation of the frame design.

14. The method as recited in claim 1, wherein generating a frame design corresponding to the configured positions for each of the one or more components includes generating a textual file of the frame design.

15. A computer-readable medium having computer-executable instructions for performing the method recited in claim 1.

16. A computer system having a processor, a memory and an operating environment, the computer system for performing the method recited in claim 1.

17. A method for generating frame designs for manufacturing a vehicle, the method comprising:
(a) obtaining a specification of one or more components to be mounted on a frame of a vehicle,
(b) obtaining processing data corresponding to each of the one or more components to be mounted on the frame of the vehicle, wherein the processing data includes location information corresponding to a logical starting position for attempting to locate a component on the frame and a range of additional dimensional positions to locate the component and three-dimensional data corresponding to a tessellated representation of the component;
(c) selecting a component of the one or more components and setting a current position as the starting position in the processing data;
(d) configuring a position for the selected component based upon determining whether a tessellated representation of the selected component interferes with the tessellated representation of any other components already configured to the frame;
(g) repeating (d) for any remaining components of the one or more components; and
(h) generating a frame design corresponding to the configured positions for each of the one or more components.

18. The method as recited in claim 17, wherein determining whether a tessellated representation of the selected component interferes with the tessellated representation of any other components already configured to the frame includes iteratively comparing whether any tessellated planes within the three-dimensional data of the selected component intersect with any tessellated planes with the three-dimensional data of any components already configured to the frame.

19. The method as recited in claim 17, wherein determining whether the tessellated representation of the selected component located at the current position interferes with the tessellated representation of any other components already configured to the frame includes determining whether the selected component located at the current position is located within another configured component.

20. The method as recited in claim 17, wherein obtaining a specification of one or more components to be mounted on a frame of a vehicle includes obtaining a list of required components from a user interface.

21. The method as recited in claim 17, wherein the logical starting position corresponds to a dimensional measurement relative to the frame.

22. The method as recited in claim 17, wherein the logical starting position corresponds to a dimensional measurement relative to another component.

23. The method as recited in claim 17, wherein the range of additional positions to locate the component includes a maximum dimensional measurement in a first direction from the logical starting position.

24. The method as recited in claim 23, wherein the range of additional positions to locate the component includes a maximum dimensional measurement in a second direction from the logical starting position.

25. The method as recited in claim 17, further comprising configuring a new position for the selected component based upon determining whether the selected component fits with any existing holes on the frame for attaching a component.

26. The method as recited in claim 25, wherein configuring a new position for the selected component based upon determining whether the selected component fits with any existing holes on the frame for attaching a component includes:
determining whether the selected component fits with any existing holes on the frame for attaching a component at the previously configured position;
if the selected component fits with any existing holes on the frame for attaching a component, determining whether the tessellated representation of the selected component located at a position corresponding to a matching hole interferes with the tessellated representation of any other components already configured to the frame;
if no interference occurs, configuring the position of the component as the position corresponding to a matching hole.

27. The method as recited in claim 17, wherein generating a frame design corresponding to the configured positions for each of the one or more components includes generating a three-dimensional representation of the frame design.

28. The method as recited in claim 17, wherein generating a frame design corresponding to the configured positions for each of the one or more components includes generating a textual file of the frame design.

29. The method as recited in claim 17, wherein obtaining processing data corresponding to one or more components includes traversing a tree structure to select a set of processing data.

30. The method as recited in claim 29, wherein the tree structure includes two or more sets of processing data for a selected component and wherein setting a next position in the range of additional positions defined in the processing data includes selecting a new set of processing data and obtaining a next position.

31. A computer-readable medium having computer-executable instructions for performing the method recited in claim 17.

32. A computer system having a processor, a memory and an operating environment, the computer system for performing the method recited in claim 17.

33. A computer-readable medium having computer-executable modules for generating frame designs for manufacturing a vehicle, the computer-executable modules comprising:
an interface module for obtaining a specification of one or more components to be mounted on a frame of a vehicle and for transmitting a frame design corresponding to a configuration of the components mounted on the frame of the vehicle;
a processing data module for storing processing data corresponding to each of the one or more components to be mounted on the frame of the vehicle, wherein the processing data includes location information corresponding to a logical starting position for attempting to locate a component on the frame and a range of additional positions to locate the component and three-dimensional data corresponding to a tessellated representation of the component; and
a configuration module for configuring a location for a selected component of the one or more components to be mounted on a frame of a vehicle based upon an interference check corresponding to comparison of a tessellated representation of the selected component interferes with the tessellated representation of any other components already configured to the frame.

34. The computer-readable medium as recited in claim 33, wherein the interference check includes iteratively comparing whether any tessellated planes within the three-dimensional data of the selected component intersect with any tessellated planes with the three-dimensional data of any components already configured to the frame.

35. The computer-readable medium as recited in claim 33, wherein the logical starting position corresponds to a dimensional measurement relative to the frame.

36. The computer-readable medium as recited in claim 33, wherein the logical starting position corresponds to a dimensional measurement relative to another component.

37. The computer-readable medium as recited in claim 33, wherein the range of additional positions to locate the component includes a maximum dimensional measurement in a first direction from the logical starting position.

38. The computer-readable medium as recited in claim 37, wherein the range of additional positions to locate the component includes a maximum dimensional measurement in a second direction from the logical starting position.

39. The computer-readable medium as recited in claim 33, wherein the configuration module is further operable for configuring a new position for the selected component based upon determining whether the selected component fits with any existing holes on the frame for attaching a component.

40. The computer-readable medium as recited in claim 39, wherein configuring a new position for the selected component based upon determining whether the selected component fits with any existing holes on the frame for attaching a component includes:
determining whether the selected component fits with any existing holes on the frame for attaching a component at the previously configured position;
if the selected component fits with any existing holes on the frame for attaching a component, determining whether the tessellated representation of the selected component located at a position corresponding to a matching hole interferes with the tessellated representation of any other components already configured to the frame;
if no interference occurs, configuring the position of the component as the position corresponding to a matching hole.

41. The computer-readable medium as recited in claim 33, wherein the processing module selects the processing data by traversing a tree structure.

42. The computer-readable medium as recited in claim 41, wherein the tree structure includes two or more set of processing data for a selected component and wherein the configuration module selects a next position in the range of additional positions defined in the processing data by selecting a new set of processing data from the processing module and obtaining a next position for the component from the new set of processing data.
